(19) United States
(12) Patent Application Publication
(10) Pub. No.: US 2010/0245322 A1
(43) Pub. Date: Sep. 30, 2010

(54) DISPLAY DRIVING DEVICE

(75) Inventor: Yuichi Nakanishi, Kanagawa (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/721,213

(22) Filed: Mar. 10, 2010

(30) Foreign Application Priority Data
Mar. 27, 2009 (JP) 2009-079876

(51) Int. Cl. G09G 5/00

(52) U.S. Cl. 345/211

(57) ABSTRACT

The amount of communication with an external MCU can be reduced to reduce power consumption, and reduced power consumption and reduced cost can also be anticipated in the external MCU. An MCU first transmits old image data and new image data from image memory to a register by serial communication without modifying the data and with substantially no computational processing thereof. Combinations of waveform data necessary for displaying a color is then stored in a waveform latch circuit from a waveform data shift register and a combination of waveform data is selectively outputted by each of a group of 4-to-1 selectors. Data transmission from the external MCU from the waveform data shift register to the waveform latch circuit is thereby restricted to the initial stage.

### BACKGROUND OF THE INVENTION

1. Field of the Invention

The present invention relates to a display driving device (e.g., a driver IC composed of an integrated circuit (hereinafter referred to as “IC”)) for driving a display device (e.g., a panel display), and particularly relates to a low-power-consumption scheme for a display driving device.

2. Description of the Related Art

Conventionally, markets have not arose for display driving devices for image writing, such as for cholesteric liquid crystal, which has the characteristic of reflecting only specific wavelengths (of light) and is used in electronic paper. As a consequence, existing STN (super twisted nematic) driving devices and the like appear to have been diverted for such uses in many instances.

Due to the nature of the cholesteric liquid crystal used in electronic paper, a characteristic method is used for writing the display data. Plainly speaking, rather than merely writing new display data, it is often the case that writing as pre-processing is required according to the conditions of old display data. Driving devices for electronic paper technologically developed in the wake of STN driving devices are often provided with total display reset writing and other functions.

FIG. 1 is a view showing a typical example of the display operation performed during writing to a conventional cholesteric liquid crystal display panel (hereinafter referred to simply as “liquid crystal display panel”).

The liquid crystal display panel 10 has a plurality of shared electrodes (i.e., common electrodes) COM, and a plurality of segment electrodes SEG orthogonal to the shared electrodes COM, and cholesteric liquid crystal display elements (referred to hereinafter as “liquid crystal display elements”) 11 are formed at the intersections of the common electrodes COM with the segment electrodes SEG. Pixels (PIXEL) composed of the liquid crystal display elements 11 display colors (e.g., white and black in monochromatic display) by a synthetic voltage in which a common voltage Vcom applied to the shared electrodes COM and a segment voltage Vseg applied to the segment electrodes SEG are synthesized.

In FIG. 1, in the case of white (W) and black (B) monochromatic display, the common voltage Vcom changes to the logical values “L” (=“0”), “½,” and “H” (=“1”). The segment voltage Vseg changes to “L” (=“0”), “½,” and “H” (=“1”). The pixel voltage Vpixel that is the synthesis of the common voltage Vcom and the segment voltage Vseg changes to the logical values of “L” (=“−1”), “0,” and “H” (=“1”). These three values “0, ½, 1” can be represented by two bits.

The output phase periods (1) through (5) from start (BEGIN) to completion (END) show the output waveform of the display driving device for writing a new image to the liquid crystal display panel 10. In the example of display operation shown in FIG. 1, the common voltage Vcom applied to the shared electrodes COM changes from logical “H” to “L” twice. During this period, the segment voltage Vseg for each pixel (PIXEL) must repeat black (B) writing and white (W) writing, due to the relationship between the old display and the new display. This is the previously described pre-process writing that is required according to the conditions of the old display data.

In FIG. 1, black (B) is written when Vcom>Vseg, white (W) is written when Vcom<Vseg, and there is no display change when Vcom=Vseg. Due to the characteristics of the display panel, a certain threshold voltage is used to determine the voltage size relationships described above, and the size relationships apply and a color is written only when the potential difference exceeds the threshold voltage.

FIG. 2 is a basic circuit diagram of the conventional display driving device for electronic paper.

A display driving device 30 is connected to an image memory 21 and a microcontroller unit (hereinafter referred to as “MCU”) 20 that is a memory control device, and a liquid crystal display panel 10 is connected to the display driving device 30.

The liquid crystal display panel 10 has a plurality of common electrodes COM, and a plurality of segment electrodes SEG1 through SEGx orthogonal to the common electrodes COM, and liquid crystal display elements 11 are formed at the intersections of the common electrodes COM with the segment electrodes SEG1 through SEGx. Only one common electrode COM is shown in order to simplify the description.

The MCU 20 has a function for accessing the image memory 21 for storing image data DATA, and a function for outputting a clock signal SCLK, a latch enable signal LN, and a system reset signal nRESET and controlling the display driving device 30.

The display driving device 30 is controlled by the MCU 20, and is a device for driving an image display in the liquid crystal display panel 10 on the basis of serial image data DATA that are fed from the image memory 21 accessed by the MCU 20. The display driving device 30 has a data shift register 31 for taking in serial image data DATA in sequence on the basis of the clock signal SCLK, and a data latch circuit 32 is connected to the output side of the data shift register 31. The data latch circuit 32 is a circuit for latching parallel image data outputted from the data shift register 31 according to the latch enable signal LN, and a driver 33 is connected to the output side of the data latch circuit 32. The driver 33 is a circuit for driving the parallel image data outputted from the data latch circuit 32 and applying the segment voltages Vseg1 through Vsegx and the common voltage Vcom to the segment electrodes SEG1 through SEGx and the common electrodes COM, respectively.

As an example of a technique relating to a display driving device 30 such as described above, Japanese Patent Kokai No. 2001-282192 discloses a display driving device for driving the common electrodes COM of a liquid crystal display elements 11 that have memory properties.

In the MCU 20 for controlling the display driving device 30, the following routines (a) through (e), for example, are repeated five times as a rewrite operation for the liquid crystal display panel 10.

(a) White or black image data DATA displayed in the previous cycle are read from the image memory 21.

(b) White or black image data DATA to be displayed in the current cycle are read from the image memory 21.

(c) Voltage levels to be outputted to the liquid crystal display panel 10 are determined from the image data DATA of (a) and (b) through computation or loading.

(d) The image data DATA of all the segment voltages Vseg1 through Vsegx and the common voltage Vcom as output voltage information are transferred to the display driving device 30 by serial communication.

(e) The latch enable signal LN is asserted, and the output voltage of the driver 33 is changed (i.e., driven).

The display driving device 30 operates as described below under such control by the MCU 20.

In the data shift register 31, the image data DATA for driver output are incorporated by serial communication, and after all of the image data DATA have been incorporated, the data are incorporated at once into the data latch circuit 32 by the latch enable signal LN. A voltage in accordance with the data “H” or “L” incorporated into the data latch circuit 32 is generated by the driver 33 and outputted to the liquid crystal display panel 10, and writing to the liquid crystal display panel 10 is performed.

### SUMMARY OF THE INVENTION

However, the conventional display driving device 30 has such drawbacks as the following.

For example, in order to obtain an output waveform such as the one shown in FIG. 1, serial transfer of image data DATA from the MCU 20 to the data shift register 31 must be repeated 5×2 times, and the information to be outputted must be written to the data latch circuit 32. The “2” in “5×2 times” indicates 2-bit data in which the output has three values.

Although not a significant problem when there are a small number of segment electrodes SEG1 through SEGx, the amount of power consumed for writing increases as the number of segment electrodes SEG1 through SEGx increases, and the load on the MCU 20 for writing and processing the image data DATA also increases. Increased load on the MCU 20 translates to increased power consumption by the MCU 20.

The display driving device of the present invention is a display driving device for driving a display panel in which waveform data are determined from the relationship between old display data and new display data; and the display driving device comprises a first circuit for storing the new display data presented from an external source and outputting a first selection control signal that is generated based on the new display data; a second circuit for storing the old display data presented from an external source and outputting a second selection control signal that is generated based on the old display data; a waveform latch circuit for outputting the waveform data determined from the relationship between the old display data and new display data; a selector for selecting and outputting selected one of the waveform data on the basis of the first and second control signals; and a drive circuit for generating drive voltages in accordance with the selected waveform data and supplying the drive voltages to the display panel.

Through the present invention, the amount of communication with an external control device can be reduced, and power consumption can thereby be reduced. Since the display driving device of the present invention can be operated even when the control device is of low performance, the power consumption and cost of the control device can also be reduced.

### BRIEF DESCRIPTION OF THE DRAWINGS

FIG. 1 is a view showing the display operation during writing to the conventional liquid crystal display panel;

FIG. 2 is a basic circuit diagram showing the conventional display driving device; and

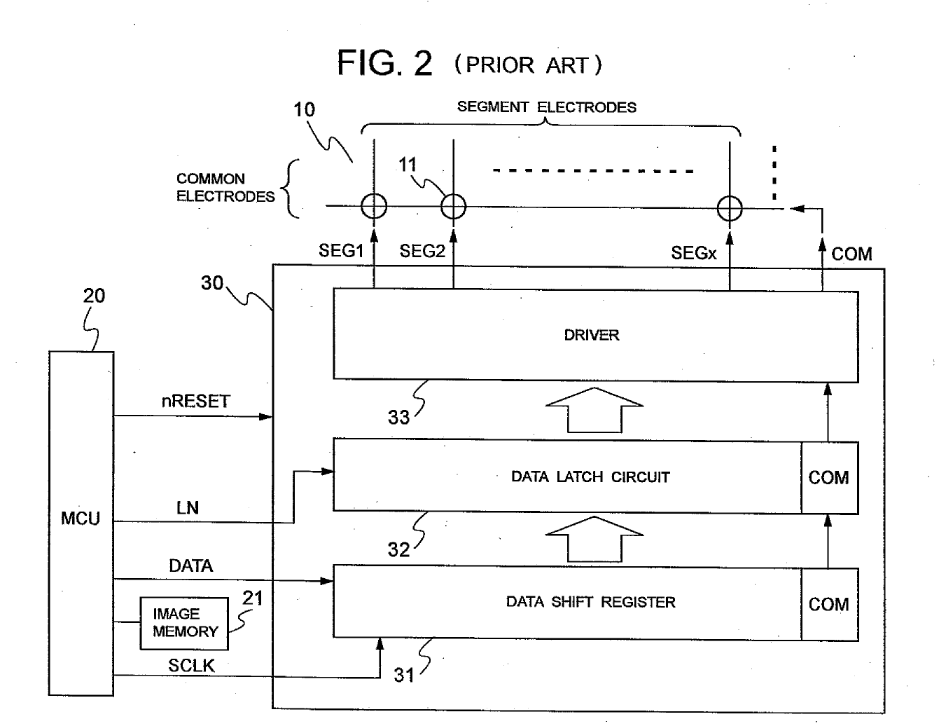

FIG. 3 is a basic circuit diagram showing the display driving device according to Embodiment 1 of the present invention.

### DESCRIPTION OF THE PREFERRED EMBODIMENTS

Embodiments of the present invention will become clear from reading the following description of preferred working examples with reference to the attached drawings. However, the drawings are provided for illustration only and not for the purpose of limiting the scope of the invention.

### Embodiment 1

(Structure of Embodiment 1)

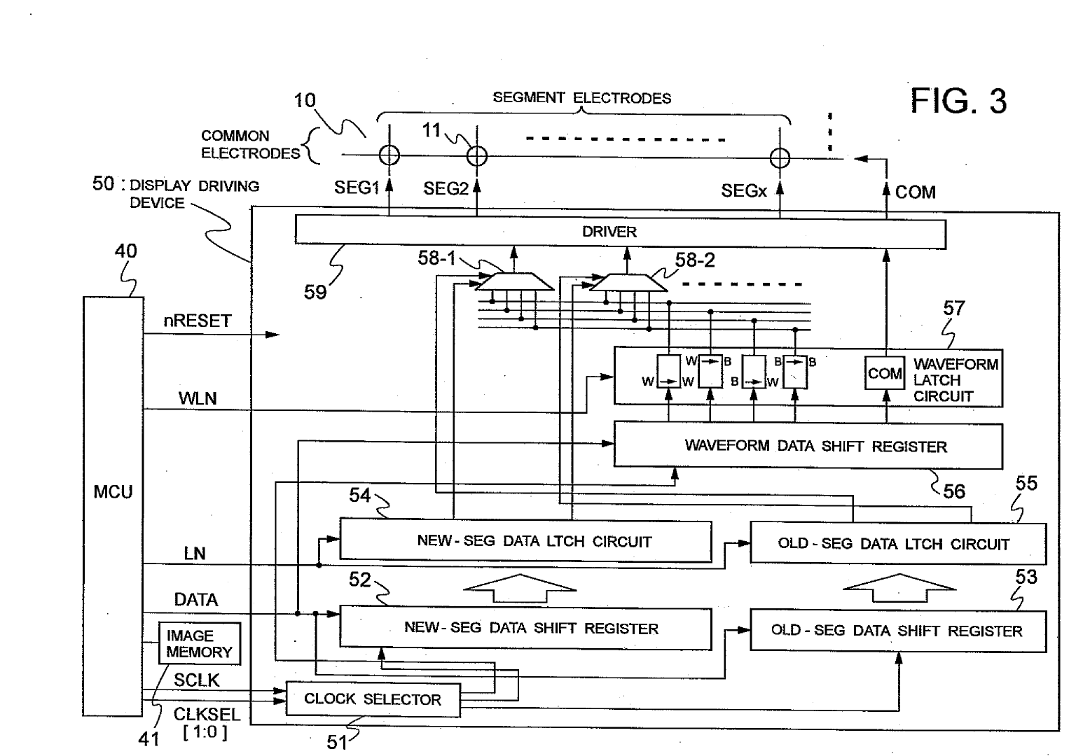

FIG. 3 is a basic circuit diagram showing the display driving device for electronic paper according to Embodiment 1 of the present invention.

A display driving device 50 is connected to an external control device (e.g., an external MCU) 40 and an image memory 41, and a liquid crystal display panel 10 that is the same as a conventional liquid crystal display panel is connected to the display driving device 50.

The MCU 40 has a function for accessing the image memory 41 for storing image data DATA, and a function for outputting a plurality of control signals and controlling the display driving device 50. The plurality of control signals are, for example, a signal CLKSEL [1:0] for providing notification of a type to be transferred by serial communication, a clock signal SCLK for serial data transfer, image data DATA for serial data transfer, a latch enable signal LN for latching the serial-transferred image data DATA, a latch enable signal WLN for latching waveform data that are transferred by serial communication, and a system reset signal nRESET.

The display driving device 50 is controlled by the MCU 40, and is a device for driving image display in the liquid crystal display panel 10 on the basis of serial image data DATA that are fed from the image memory 41 accessed by the MCU 40. The display driving device 50 has a clock selector 51, and storage means or data retention means (e.g., a new-SEG data shift register 52, an old-SEG data shift register 53, and a waveform data shift register 56 for segment/common output) are connected to the output side of the clock selector 51. A new-SEG data latch circuit 54 is connected to the output side of the new-SEG data shift register 52, and an old-SEG data latch circuit 55 is connected to the output side of the old-SEG data shift register 53. A waveform latch circuit 57 is connected to the output side of the waveform data shift register 56, and a driver 59 is connected to the output side of the waveform latch circuit 57 via selectors (e.g., a group of 4-to-1 selectors 58-1, 58-2, and so on).

The clock selector 51 controls which of the shift registers 52, 53, 56 the serial communication data is to be stored in, on the basis of the signal CLKSEL [1:0] and the clock signal SCLK. The new-SEG data shift register 52 is a register for incorporating serial new image data DATA and converting the serial new image data DATA to parallel data, through the control of the clock selector 51. The old-SEG data shift register 53 is a register for incorporating serial old image data DATA and converting the serial old image data DATA to parallel data, through the control of the clock selector 51.

The new-SEG data latch circuit 54 is a circuit for incorporating parallel data from the new-SEG data shift register 52 through the latch enable signal LN. The new-SEG data latch circuit 54 also outputs a first selection control signal to the group of 4-to-1 selectors 58-1, 58-2, and so on described hereinafter. The first selection control signal is a signal that is generated based on the parallel data from the new-SEG data shift register 52; specifically, the first selection control signal is generated based on the serial new image data DATA. The old-SEG data latch circuit 55 is a circuit for incorporating the parallel data from the old-SEG data shift register 53 through the latch enable signal LN. The old-SEG data shift register 53 also outputs a second selection control signal to the group of 4-to-1 selectors 58-1, 58-2, and so on described hereinafter. The second selection control signal is a signal that is generated based on the parallel data from the clock selector 51; specifically, the second selection control signal is generated based on the serial old image data DATA. The waveform data shift register 56 for segment and common output is a register for incorporating the serial waveform data DATA and converting the serial waveform data DATA to parallel waveform data, through the control of the clock selector 51. The waveform latch circuit 57 is a circuit for incorporating the parallel waveform data from the waveform data shift register 56, through the latch enable signal WLN.

The 4-to-1 selectors 58-1, 58-2, and so on are provided in number corresponding to the number of segment electrodes, and are circuits for respectively selecting one of the waveform data of four types of combinations (4-to-1) of old-image and new-image waveform data from the waveform latch circuit 57 on the basis of the first and second selection control signals outputted from the new-SEG data latch circuit 54 and the old-SEG data latch circuit 55. Moreover, the driver 59 is a circuit for receiving the waveform data selected by the 4-to-1 selectors 58-1, 58-2, and so on, generating segment voltages Vseg1 through Vsegx and a common voltage Vcom in accordance with the waveform data, and supplying the segment voltages Vseg1 through Vsegx and the common voltage Vcom to the segment electrodes SEG1 through SEGx and the common electrodes COM, respectively.

(Operation of Embodiment 1)

In the MCU 40 for controlling the display driving device 50, the following routines (a) through (g), for example, are performed as a rewrite operation for the liquid crystal display panel 10.

(a) White (W) or black (B) image data DATA displayed in the previous cycle are read from the image memory 41.

(b) The image data DATA of (a) are transferred to the old-SEG data shift register 53 by serial communication.

(c) White (W) or black (B) image data DATA to be displayed in the current cycle are read from the image memory 41.

(d) The image data DATA of (c) are transferred to the new-SEG data shift register 52 by serial communication.

(e) The latch enable signal LN is asserted, and combination image data DATA are stored in each of the old-SEG data latch circuit 55 and the new-SEG data latch circuit 54.

(f) Output voltage information data DATA are transferred to the waveform data shift register 56 in relation to common information and combinations of four types of segment information (W→W, W→B, B→W, B→B) by serial communication.

(g) The latch enable signal WLN is asserted, and after the parallel output data of the waveform data shift register 56 is stored in the waveform latch circuit 57, the output voltage of the display driving device 50 is changed (i.e., driven) via the 4-to-1 selectors 58-1, 58-2, and so on and the driver 59.

The rewrite operation for the liquid crystal display panel 10 is performed by repeating (f) through (g) five times.

The display driving device 50 operates according to steps S1 through S11 below through control by the MCU 40 such as described above.

Step S1:

When the system reset signal nRESET is presented from the MCU 40, all of the registers 52, 53, 56 and the latch circuits 54, 55, 57 are reset.

Step S2:

The signal CLKSEL [1:0] is presented to the clock selector 51 from the MCU 40, and the clock selector 51 sets the type of data for serial communication to old-image data.

Step S3:

Black (B) or white (W) old image data DATA are transferred from the MCU 40 to the old-SEG data shift register 53 by serial communication. The old-SEG data shift register 53 sequentially shifts the old image data DATA transferred by serial communication, and converts the old image data DATA to parallel data.

Step S4:

The next signal CLKSEL [1:0] is presented to the clock selector 51 from the MCU 40, and the clock selector 51 sets the type of data for serial communication to new-image data.

Step S5:

Black (B) or white (W) new image data DATA are transferred from the MCU 40 to the new-SEG data shift register 52 by serial communication. The new-SEG data shift register 52 sequentially shifts the new image data DATA transferred by serial communication, and converts the new image data DATA to parallel data.

Step S6:

The latch enable signal LN presented from the MCU 40 to the new-SEG data latch circuit 54 and the old-SEG data latch circuit 55 is asserted. The new-SEG data latch circuit 54 and the old-SEG data latch circuit 55 thereby incorporate the parallel new image data and parallel old image data that are outputted from the new-SEG data shift register 52 and the old-SEG data shift register 53, respectively. The latch enable signal LN is then disabled.

Step S7:

The next signal CLKSEL [1:0] is presented from the MCU 40 to the clock selector 51, and the clock selector 51 sets the type of data for serial communication to waveform data.

Step S8:

The segment and common waveform data DATA are transferred from the MCU 40 to the waveform data shift register 56 by serial communication. The waveform data shift register 56 sequentially shifts the segment and common waveform data DATA transferred by serial communication, and converts the segment and common waveform data DATA to parallel data.

Step S9:

The latch enable signal WLN presented to the waveform latch circuit 57 from the MCU 40 is asserted. The waveform latch circuit 57 thereby incorporates the parallel segment and common waveform data that are outputted from the waveform data shift register 56. This incorporation takes place at the time the driver output changes. The latch enable signal WLN is then disabled. The segment and common waveform data incorporated by the waveform latch circuit 57 are received by the driver 59 after being selected by the group of 4-to-1 selectors 58-1, 58-2, and so on, and the segment voltages Vseg1 through Vsegx and the common voltage Vcom generated by the driver 59 are supplied to the segment electrodes SEG1 through SEGx and the common electrodes COM, respectively, the segment and common waveform data are written to the liquid crystal display elements 11, and an image is displayed.

Step S10:

Steps S7 through S8 are repeated a number of times commensurate with the necessary output waveform (e.g., five times).

Step S11:

Writing to the liquid crystal display elements 11 is completed.

(Effect of Embodiment 1)

Such effects as described in (A) through (D) below are obtained through Embodiment 1.

(A) Effect 1

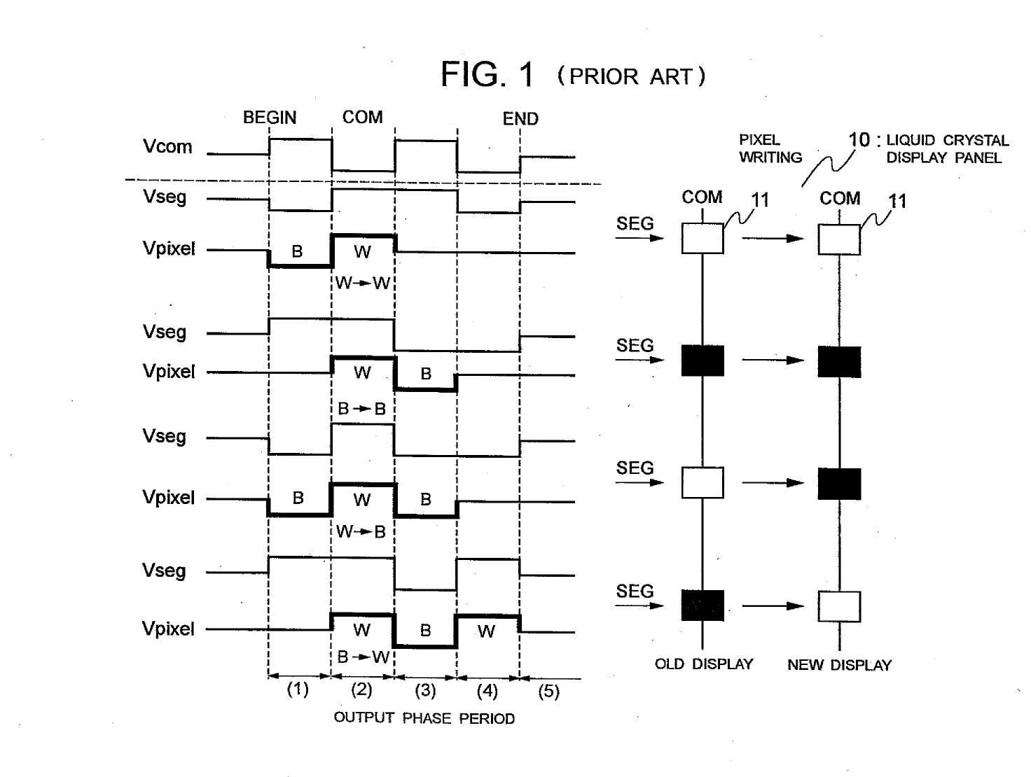

In the conventional display driving device 30, all of the data of the five periods (1) through (5) shown in FIG. 1 that are necessary for displaying a color are transmitted from the data shift register 31 to the data latch circuit 32. In the display driving device 50 of Embodiment 1, however, combinations (of which there are four possible) of waveform data of the five periods (1) through (5) shown in FIG. 1 that are necessary for displaying a color is first stored in the waveform latch circuit 57 and then one of the combinations is respectively selected by the group of 4-to-1 selectors 58-1, 58-2, and so on for output. Data transmission from the external MCU 40 from the waveform data shift register 56 to the waveform latch circuit 57 is thereby restricted to the initial stage, and the amount of current used in communication can thereby be markedly reduced.

In other words, in the conventional technique, data are always being transmitted from the external MCU 20 for communication from the data shift register 31 to the data latch circuit 32. In the case of Embodiment 1, however, data are transmitted from the external MCU 40 for communication from the waveform data shift register 56 to the waveform latch circuit 57 in the initial stage of communication, but after the initial stage, no data are transmitted from the external MCU 40 for communication from the waveform data shift register 56 to the waveform latch circuit 57. The power consumption of the external MCU 40 that operates for communication from the waveform data shift register 56 to the waveform latch circuit 57 can therefore be reduced.

Consequently, according to Embodiment 1, by reducing the amount of communication, even a low-power, low-performance MCU 40 can be used, and the cost and power consumption of the MCU 40 can therefore be reduced.

(B) Specific Example of (A)

In the case of the conventional display driving device 30, the number of cycles of serial communication required to generate phase waveforms five times for the liquid crystal display panel 10 shown in FIG. 1 can simply be calculated using the following formula.

5×2×x cycles

The “2” in this formula indicates a case such as shown in FIG. 1 in which the data is 2-bit, and “x” indicates the sum of the segment number and common number (wherein x is an arbitrary value). The reason for this is that the waveform outputted from the driver 59 must be presented as data for each rewriting phase of the liquid crystal display panel.

In contrast, the number of cycles in serial communication according to the display driving device 50 of Embodiment 1 is indicated by the formula below.

(2×x)+(5×4×2)cycles

In this formula, “2×x” indicates the number of transfers of old image data and new image data, the “5” in 5×4×2″ indicates the phase of five instances of writing to the liquid crystal display panel, and the “4” indicates that there are four combinations of old image data and new image data. Moreover, the “2” indicates the four types of waveform data are 2-bit data.

The larger the number of segment electrodes SEG1 through SEGx is, the more that 40 cycles (=5×4×2) can be nearly ignored, and the difference in the number of cycles of serial communication between the conventional display driving device 30 and the display driving device 50 of Embodiment 1 can be approximated as 8×x. For example, supposing that the sum of the number of segment electrodes SEG1 through SEGx and common electrodes COM is 1000, 8000 cycles of serial communication are no longer needed, and it is apparent that less power is consumed for serial communication in Embodiment 1.

(C) Effect 2

The effect of Embodiment 1 will be described from the perspective of data processing by the MCU 40 for serially communicating with the display driving device 50.

In the conventional MCU 20, the data DATA of prior display and subsequent display are obtained for all of the segment electrodes SEG1 through SEGx, and the output voltage information of all the segment electrodes SEG1 through SEGx must be serially communicated. In the MCU 40 of Embodiment 1, however, the display data DATA information are serially communicated as such to the shift registers 52, 53, and only the four combinations of output voltages (W→W, W→B, B→W, B→B) and the waveform data DATA of the common electrodes COM are computed (or loaded) and serially communicated to the register 56. Therefore, the amount of data for serial transfer is significantly greater in the conventional MCU 20 than in the MCU 40 of Embodiment 1, and the processing power required for computation in the MCU 20 and MCU 40 is significantly greater in the conventional MCU 20 than in the MCU 40 of Embodiment 1.

(D) Detailed Description of (C)

When the conventional display driving device 30 is used, in order to generate the five waveform phases (1) through (5) shown in FIG. 1, the next data to be driven must be computed on the MCU 20 side from the old image data and new image data read from the image memory 21 for each phase, and the data DATA must be transmitted to the data shift register 31 using serial communication. The computations for this data transfer and the serial communication must also be completed in one output phase period (of the periods (1), (2), (3), (4) shown in FIG. 1) of the display driving device 30, and the larger the number of segment electrodes SEG1 through SEGx is, the more speed is required in computational processing and serial communication.

In contrast, when the display driving device 50 of Embodiment 1 is used, the MCU 40 can first transmit the old image data and new image data that are read from the image memory 41 to the registers 52, 53 by serial communication without modification and with almost no computational processing of the data. The waveform data DATA of each combination then need only be serially communicated to the register 56 in one output phase period (of the periods (1), (2), (3), (4) shown in FIG. 1) of the display driving device 50. Therefore, even when the number of segment electrodes SEG1 through SEGx is increased, only the number of data transfers in the initial (prior to (1) in FIG. 1) serial communication increases, and there is no difference in the amount of subsequent computation.

It is therefore apparent that the use of an MCU 40 having low computational capability presents no problems when the display driving device 50 of Embodiment 1 is used. The fact that an MCU 40 having low computational capability can be used means that less power may be consumed by the MCU 40.

(Modification)

The present invention is not limited to Embodiment 1, and various modes of utilization and modifications of the present invention are possible. Examples of such modes of utilization and modifications include (a) through (e) described below.

(a) A low-power-consumption scheme in a display driving device 50 for electronic paper was described in Embodiment 1, but this scheme can be applied to display driving devices for all types of display panels that have the characteristic of a driving waveform determined by old image data and new image data.

(b) In Embodiment 1, a configuration is adopted in which the waveform data DATA are transferred from the external MCU 40 by serial communication (waveform latch circuit 57 and waveform data shift register 56 shown in FIG. 3 (*1)), but this configuration is merely adopted so that the output waveform can be freely set to enable general-purpose application. When the application involves a display panel in which the specification output waveform is fixed, i.e., in the case of developing a display driving device for a display panel that has a specific application, data generation means may also be provided for generating a waveform that is determined within the display driving device.

(c) In Embodiment 1, latch circuits 54, 55 are provided for temporarily latching the old image data and new image data internally after the old image data and new image data have been transferred, but when clock feeding is completely interrupted by the signal CLKSEL, since the waveform outputted by the display driving device 50 is dependent on the output of the internal waveform latch circuit 57, the latch circuits 54, 55 may be omitted, and the unmodified shift register output of the registers 52, 53 may be used as the selection control signal of the selectors 58-1, 58-2, and so on.

(d) Data are transferred by serial communication in Embodiment 1, but this configuration is only one form of data transfer, and the effect of reducing the number of data transfers can also be obtained by another communication standard. In Embodiment 1, new and old display data are stored by the shift registers 52, 53 and the latch circuits 54, 55, but a method whereby memory is internally mounted to store new and old display data is also encompassed by the present invention.

(e) A single common electrode COM is described as being provided in Embodiment 1, but the number of common electrodes COM is not limited by this example, and cases in which a plurality of common electrodes COM is needed are also encompassed by the present invention.

This application is based on Japanese Patent Application No. 2009-079876 which is incorporated herein by reference.

What is claimed is:

1. A display driving device for driving a display panel in which waveform data are determined from the relationship between old display data and new display data; said display driving device comprising:
a first circuit for storing said new display data presented from an external source and outputting a first selection control signal that is generated based on said new display data;
a second circuit for storing said old display data presented from an external source and outputting a second selection control signal that is generated based on said old display data;
a waveform latch circuit for outputting said waveform data determined from the relationship between said old display data and new display data;
a selector for selecting and outputting selected one of said waveform data on the basis of said first and second control signals; and
a drive circuit for generating drive voltages in accordance with said selected waveform data and supplying said drive voltages to said display panel.

2. The display driving device according to claim 1, wherein
said first circuit comprises:
a first data shift register for storing said new display data presented from said external source; and
a first data latch circuit for incorporating said new display data from said first data shift register and outputting said first selection control signal that is generated based on said new display data; and
said second circuit comprises:
a second data shift register for storing said old display data presented from said external source; and
a second data latch circuit for incorporating said old display data from said second data shift register and outputting said second selection control signal that is generated based on said old display data.

3. The display driving device according to claim 2, wherein said first data shift register is a register which receives said new display data presented from said external source in a serial form and converts said new display data into a parallel form, and said second data shift register is a register which receives said old display data presented from said external source in a serial form and converts said old display data into a parallel form.

4. The display driving device according to claim 2, further comprising a shift register which supplies waveform data to said waveform latch circuit, wherein display data from an image memory is respectively supplied to said shift register, said first data shift register and said second data shift register.

5. The display driving device according to claim 1, wherein said selector selects and outputs one of four types of waveform data.

6. The display driving device according to claim 2, wherein said selector selects and outputs one of four types of waveform data.

7. The display driving device according to claim 1, wherein said display panel has a plurality of pixels, and said selector is provided in number corresponding to the number of said pixels.
